(19) United States
(12) Patent Application Publication
(10) Pub. No.: US 2018/0229983 A1
(43) Pub. Date: Aug. 16, 2018

(54) Winch Assembly and Method of Use

(71) Applicant: Alfred Cheyne Engineering Limited, Turriff (GB)

(72) Inventor: John Isherwood, Turiff (GB)

(21) Appl. No.: 15/504,261

(22) PCT Filed: Aug. 14, 2015
(86) PCT No.: PCT/GB2015/052364

§ 371 Date: Feb. 15, 2017

(30) Foreign Application Priority Data
Aug. 19, 2014 (GB) 1414739.1

(51) Int. Cl. B66D 1/38

(52) U.S. Cl. CPC B66D 1/38; B65H 75/4402; B65H 2701/35

(57) ABSTRACT

A winch assembly (10) comprising a winch pedestal (12), a winch drum motor (14) mounted on a winch drum drive shaft (15) and configured to be driven to rotate on the winch pedestal about a winch axis and a spooling carriage (20) supported by at least one support arm (22, 24). The at least one support arm is pivotally connected to the winch pedestal via a hub. The hub surrounds the winch axis and pivotal movement of the at least one support arm rotates the spooling carriage relative to the winch pedestal.

The present invention relates to winch assemblies which use a winch drum motor to spool cables and other lines onto and off winch drums, and in particular to an improved spooling carriage for use in such winch assemblies. Aspects of the invention include a winch assembly including such a spooling carriage and a method of use.

### BACKGROUND TO THE INVENTION

Winch assemblies are required to perform a range of tasks for example winding, reeling, spooling, lifting and lowering cable, rope, wire, umbilicals, pipes, cords, conduits or lines onto or from a reel, drum or spool. The reel, drum or spool typically has a central cylinder with an axis and a pair of side walls.

Typically winch assemblies utilise a spool guide to spool the cable onto or off the winch drum. The use of the spool guide mitigates problems with crushing and pinching between the spooled cable layers and facilitates the orderly spooling of cable onto or off the winch drum.

If the cable is unevenly spooled onto the winch drum it may become worn more readily and may reduce the strength and life span of the cable. The spool guide may mitigate uneven spooling by reducing gaps left between adjacent layers of spooled cable and also reduce the accumulation of spooled cable at the side wall of the winch drum.

The above-described winch drum motors and winch assemblies are generally designed to tolerate heavy loads. However, winching tasks involving pulling in or paying out heavy loads at an increased fleet angle may raise sideways or lateral forces on the spool guide. If the force is excessive the spool guide may be damaged or fail.

The range of tasks which the winch assembly may be required to perform means that the positioning and height of the winch assemblies may be required to be changed to accommodate each winching application. Constructing custom support frames and relocating a winch can be cumbersome and time consuming. Alternatively multiple winches may be provided, with each winch assigned to a specific task. However, such bespoke configurations are costly, and the footprint of multiple winches may be an issue where space is limited, such as in offshore environments.

It is an object of an aspect of the present invention to provide a winch assembly with improved productivity and/or efficiency which is capable of reliably performing a range of winching tasks over a wide range of winch cable exit angles. This is an alternative to having multiple winches for individual exit angles or additional bulky support frames to adjust the exit angle of the winch assembly.

It is another object of at least one aspect of the present invention to provide a spooling guide or spooling carriage that is capable of improving the performance of a winch assembly in which the spooling guide or spooling carriage is deployed.

It is a further object of an aspect of the present invention to provide a robust, reliable, sturdy winch assembly suitable for deployment in a wide range of winching applications which is capable of withstanding heavy load forces and sideways forces if the load is not in alignment with the spooling guide and/or winch drum and prolonging the working lifespan of the winch assembly.

Further aims and objects of the invention will become apparent from reading the following description.

### SUMMARY OF THE INVENTION

According to a first aspect of the invention, there is provided a winch assembly comprising: a winch pedestal;

a winch drum mounted on a winch drum drive shaft and configured to be driven to rotate on the winch pedestal about a winch axis; and

a spooling carriage supported by at least one support arm;

wherein the at least one support arm is pivotally connected to the winch pedestal via a hub, wherein the hub surrounds the winch axis, and wherein pivotal movement of the at least one support arm rotates the spooling carriage relative to the winch pedestal.

By pivoting the spooling carriage relative to the hub on the winch pedestal the spooling carriage may be pivoted around the winch pedestal and may achieve a wide range of winch cable exit angles or discharge angles. The variable spooling carriage may facilitate the winch cable performing a range of winching tasks resulting in improved productivity and/or efficiency.

The above invention may provide a robust, reliable and sturdy winch assembly. The use of at least one support arm to support the spooling carriage which is supported by the hub on the winch pedestal may facilitate the spooling carriage withstanding heavy winch loads and sideways forces.

The winch assembly may be used to winch and/or spool a wide variety of lines, including but not limited to cable, tether, rope, wire, wire rope, umbilical, pipe, cord or conduit.

The winch assembly preferably includes a winch drive motor. The winch drive motor may be configured to drive and/or rotate the winch drum on the winch pedestal about the winch axis. The winch drive motor may be connected to a gearbox.

The hub on the winch pedestal may be a component of the pedestal housing or a component of a pedestal motor housing.

The hub may comprise a spigot, and may comprise a pedestal motor housing spigot.

The spigot may comprise any suitable shape which allows the at least one support arm to pivotally connect to the spigot and provide load bearing support to the spooling carriage. Preferably the spigot has a cylindrical shape. Preferably the spigot comprises a load bearing surface.

The spigot may therefore be a load bearing pivot, and preferably is a load bearing pivot which is co-axial with the winch axis.

The spigot may define a cylindrical surface located on or fixed to the winch pedestal structure which pivotally supports and provides loading bearing support to the at least one support arm.

The support arm may comprise a support plate. The support plate may have an outer edge or skirt which may be upstanding from the support plate.

The outer edge or skirt of the support plate may provide structural strength to the support arm, and may provide resistance to flexing, bending and twisting of the support arm. The outer edge or skirt of the support plate may prevent flexing of the support plate about an axis which intersects the plane of the edge of the support plate. The support plate of the support arm may provide a surface for mounting of one or more components of the winch assembly, such as a control unit. Depending on the height of the outer edge of the support arm, the edge may provide protection to components mounted on the support plate from damage.

The support arm may have a spigot ring located at one end. The spigot ring may comprise a suitably sized aperture which may be configured to receive the spigot on the winch pedestal. The spigot ring aperture and the spigot may be dimensioned so that the spigot is pivotally received in the aperture. The spigot ring may be pivotally connected to the spigot and may be configured to pivot the support arms about the spigot.

Preferably the spooling carriage is supported by two support arms. More preferably both support arms are pivotally connected to the winch pedestal via the hub.

Preferably each load bearing support arm is pivotally connected to a spigot on the winch pedestal.

The arrangement of a pair of parallel laterally-spaced support arms on either side of the winch pedestal provides the spooling carriage with a rigid structure which may provide strength and support to the spooling carriage against heavy winch loads and sideways forces.

The distance between the outer surface of the winch pedestal and the inside surface of each support arm may be minimised to reduce the lateral movement of each arm relative to the winch pedestal. The close proximity of the support arms to the winch pedestal as the arms pivot about the hub on the winch pedestal may restrict lateral movement of the support arms and provide rigidity and strength to the support arms and the spooling carriage.

The arrangement of the spigot ring on support arm with the spigot on the winch pedestal may be configured to transfer the load of the support arm and any load that the support arm bears from the support arm to the winch pedestal structure.

The support arms may be configured to rotate about the spigot to align the spooling guide assembly on the spooling carriage with a predetermined desired angle relative to the horizontal and/or vertical plane. The support arms may be secured to the winch pedestal structure at this desired angle.

A locking mechanism may be configured to secure the support arms which support the spooling carriage to the winch pedestal at a desired angle relative to the horizontal and/or vertical plane.

The locking mechanism may comprise one or more securing bolts or pins to fix the support arms to the winch pedestal. Other suitable securing means may be used.

The at least one support arm may have at least one slot or hole configured to receive the one or more securing bolt or pin. The winch pedestal may have at least one corresponding slot or hole configured to receive at least one securing bolt or pin, which may facilitate the at least one support arm to be secured to the winch pedestal.

Securing the support arms to the winch pedestal may provide further rigidity to the winch structure and may provides additional support and strength to the spooling carriage. This arrangement may facilitate the spooling carriage withstanding heavy winch loads and sideways forces.

The point at which the supporting arms are secured to winch pedestal may provide load bearing support to the support arms and spooling carriage.

The load bearing support provided by the spigot and the locking mechanism may facilitate the spooling carriage and its support arms withstanding heavy loads and sideways forces.

The profile shape of the at least one support arm may comprise any suitably shaped profile which allows the at least one support arm to support the spooling carriage. The support arm may provide lateral support to the spooling carriage and facilitate the spooling carriage withstanding heavy loads and sideways forces. Preferably the profile shape of the at least one support arm is a linear shape. Alternatively the profile shape of the at least one support arm is at least a partially curved shape.

Preferably the at least one support arm pivots through an angle of at least sixty degrees. More preferably the at least one support arm pivots through an angle of approximately ninety degrees.

Preferably the at least one support arm pivots between an angle of approximately zero degrees and approximately one hundred and eighty degrees to the horizontal plane.

Preferably the at least one support arm pivots between an angle of approximately zero degrees and approximately ninety degrees to the horizontal plane.

Preferably the spooling carriage comprises a spooling guide assembly. The spooling assembly may comprise at least one spooling roller. The spooling roller may be configured to receive the line.

The spooling guide assembly may have at least two spooling rollers. The spooling rollers may be configured to receive the winch line.

The spooling guide assembly may be configured to move in a reciprocating motion, which may be in a horizontal plane. Preferably the spooling guide assembly is moved along a spooling shaft, which may be parallel to the winch axis.

By moving the spooling guide assembly in a reciprocating motion the spooling of the tensioned cable may be controlled and allow spooling in an orderly manner. Controlled spooling mitigates problems with crushing and pinching between the spooled cable layers as it is spooled onto or from a reel.

Preferably the spooling carriage comprises a spooling shaft motor. The spooling shaft motor may be configured to move the spooling guide assembly along the spooling shaft.

Preferably the winch assembly comprises a control unit configured to control the spooling shaft motor and/or the winch drive motor. More preferably the spooling shaft motor is controlled independently from the winch drive motor.

Preferably the control unit monitors one or more of the speed of the spooling shaft motor, the speed of the winch drum motor and/or the position of the spooling assembly.

The control unit may be configured to position the spooling rollers and/or monitor the position the spooling rollers as they move on the spooling shaft. The control unit may use the winch drum rotational speed, spooling shaft motor rotational speed and/or the location or horizontal motion of the spooling guide assembly to facilitate efficient spooling. The control unit may also facilitate the spooling rollers being aligned with the winch line as it is spooled onto or off the winch drum to mitigate tension on the winch line between the spooling rollers and the winch drum.

The winch assembly may comprise a second winch drive motor mounted on the drum drive shaft. The second winch drive motor may be used in combination with the first winch drive motor for winching/spooling heavy loads and/or lines. Alternatively the second winch drive motor may be used as a back-up winch drum motor.

According to a second aspect of the invention there is provided a spooling carriage for a winch assembly comprising;

a spooling guide assembly;

at least one support arm to support the spooling guide assembly;

wherein the at least one support arm is configured to be is pivotally connected to a winch pedestal via a hub surrounding a winch axis of the winch assembly.

By providing at least one support arm to support the spooling carriage it may provide strength to the spooling carriage and may facilitate the spooling carriage withstanding heavy winch loads, side loads and/or sideways lateral forces.

The position of the spooling guide assembly may be moved to any desired angle relative to the horizontal and/or vertical plane and fixed at that position by rotating at least one support arm about its pivot and the securing the at least one support arm at the desired angle relative to the horizontal and/or vertical plane.

Preferably the pivot of the at least one support arm is coaxial with the winch axis.

Preferably the spooling guide assembly comprises at least one spooling roller. Preferably the spooling guide assembly has at least two spooling rollers and the spooling rollers may be configured to receive a winch line therebetween.

The spooling guide assembly may be configured to move in a reciprocating motion, which may be in a horizontal plane. Preferably the spooling guide assembly is moved along a spooling shaft, which may be parallel to the winch axis

The spooling guide assembly may be driven from the winch drive motor. The winch drive motor may be mechanically synchronised with the spooling shaft.

Preferably the spooling guide assembly is driven independently from the winch drive motor. Preferably the spooling guide assembly is driven by a spooling shaft motor. The spooling shaft motor may be configured to move the spooling rollers along a spooling shaft.

A control unit may be configured to control the spooling shaft motor and the direction of travel of the spooling guide assembly along the spooling shaft.

The control unit may be configured to position the spooling rollers and/or monitor the position the spooling rollers as they move on the spooling shaft.

Preferably one or more sensors may be located in the spooling carriage to monitor the spooling guide assembly as it moves on the spooling shaft. At least one output signal from the one or more sensors may determine the direction that the spooling motor turns and/or the direction of travel of the guide assembly on the spooling shaft.

The control unit may monitor the winch drum rotational speed, spooling shaft motor rotational speed and/or the location or horizontal motion of the spooling guide assembly to facilitate efficient spooling.

Preferably the spooling carriage may comprise two support arms to support the spooling carriage. More preferably both support arms may be pivotally connected to a winch pedestal hub.

Embodiments of the second aspect of the invention may comprise features corresponding to the preferred or optional features of the first aspect of the invention or vice versa.

According to a third aspect of the invention there is provided a method of operating a winch assembly or spooling carriage according to a previous aspect of the invention.

Embodiments of the third aspect of the invention may comprise features corresponding to the preferred or optional features of the first or second aspects of the invention or vice versa.

According to a fourth aspect of the invention there is provided a method of configuring a winch assembly comprising the steps of:

providing a winch assembly comprising a winch pedestal; a winch drum mounted on a winch drum drive shaft on a winch axis; and a spooling carriage supported by at least one support arm;

rotating the spooling carriage relative to the winch pedestal to a desired position by pivoting the at least one support arm about a hub which surrounds the winch axis; and securing the spooling carriage relative to the winch pedestal at the desired position.

The method may comprise driving the spooling assembly independently from the winch drive motor.

The desired position may be any angle relative to the horizontal and/or vertical plane.

The method may comprise securing the spooling carriage relative to the winch pedestal at the desired angle by securing the at least one support arm to the winch pedestal. The method may use any suitable securing means such as bolts or pins.

The method may comprise stopping the winch drive motor and releasing the spooling carriage from the winch pedestal, rotating the spooling carriage relative to the winch axis to a second desired position and securing the spooling carriage at the second desired position.

Embodiments of the fourth aspect of the invention may comprise features corresponding to the preferred or optional features of the first, second or third aspects of the invention or vice versa.

According to a fifth aspect of the invention there is provided a method of operating a winch assembly comprising the steps of:

providing a winch assembly comprising:

a winch pedestal;

a winch drum mounted on a winch drum drive shaft and configured to be driven to rotate on the winch pedestal about a winch axis; and

a spooling carriage supported by at least one support arm;

wherein the at least one support arm is pivotally connected to the winch pedestal via a hub, wherein the hub surrounds the winch axis, and wherein pivotal movement of the at least one support arm rotates the spooling carriage relative to the winch pedestal; pulling in or paying out a winch line; and

transferring a sideways force acting on the line to the winch pedestal via the at least one support arm.

The method may comprise activating a winch drive motor to rotate the winch drum.

The method may comprise moving the spooling guide assembly in a reciprocating motion, along a spooling shaft. The spooling shaft may be parallel to the winch axis

The method may comprise monitoring a winch drum rotational speed to ensure that a spooling guide assembly in the spooling carriage is in the correct position to facilitate efficient spooling onto or off the winch drum.

The method may comprise monitoring the position of the spooling guide assembly on the spooling shaft to facilitate efficient spooling onto or off the winch drum.

Embodiments of the fifth aspect of the invention may comprise features corresponding to the preferred or optional features of the first to fourth aspects of the invention or vice versa.

### BRIEF DESCRIPTION OF THE DRAWINGS

There will now be described, by way of example only, various embodiments of the invention with reference to the following drawings (like reference numerals referring to like features) in which:

FIG. 1 presents a winch comprising a spooling carriage set with a discharge angle of approximately ninety degrees to the horizontal plane in accordance with an embodiment the present invention, shown in perspective view;

FIG. 2A presents the winch and spooling carriage of FIG. 1, shown in a profile view;

FIG. 2B presents the winch and a spooling carriage of FIGS. 1 and 2A shown in cross-sectional view taken along line A-A of FIG. 2A;

FIG. 3 presents the winch and spooling carriage of FIG. 1 in cross-sectional view, with components removed for clarity;

FIG. 4 presents the spooling carriage of the embodiment of FIG. 1, shown in cross-sectional view; and

FIG. 5 presents the winch and spooling carriage of FIG. 1 set with a discharge angle of approximately zero degrees to the horizontal plane, shown in perspective view.

### DETAILED DESCRIPTION OF PREFERRED EMBODIMENTS

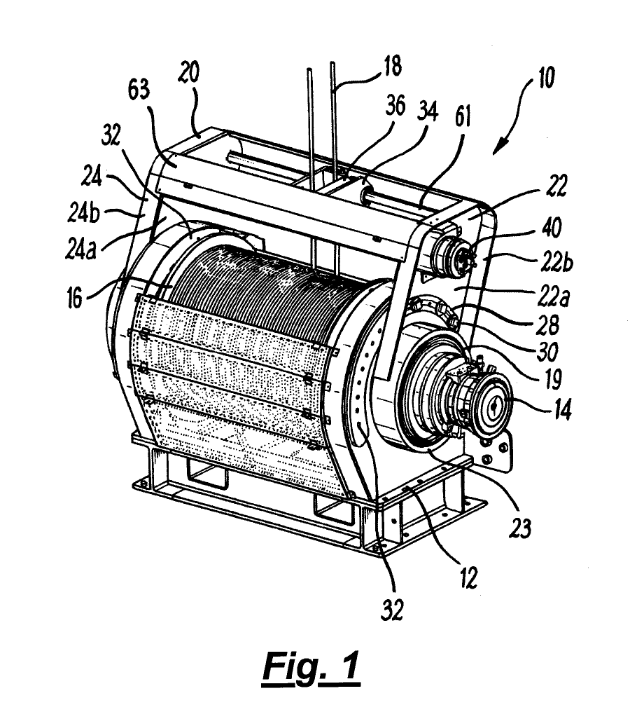

An embodiment of the present invention is illustrated in FIG. 1 and provides a number of advantages over prior art winches, specifically by providing a robust and sturdy spooling carriage which is capable of being adjusted to facilitate cable exit/entry angles between approximately zero degrees and approximately ninety degrees to the horizontal plane the winch is capable of performing a wide range of winching and spooling tasks.

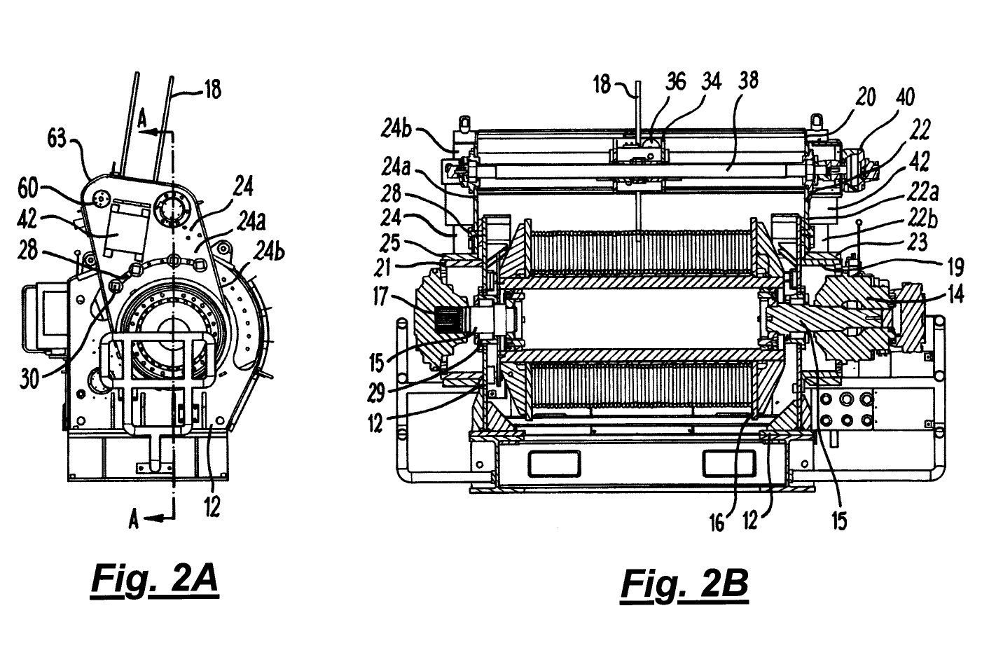

FIG. 1 shows a winch assembly 10 in perspective view. FIGS. 2A and 2B show the winch assembly in profile and cross-sectional views. As shown in FIGS. 2A and 2B, the winch assembly is configured to a slightly different discharge angle compared to the discharge angle shown in FIG. 1 to improve the clarity of the drawings. The winch assembly 10 can be seen to comprise a winch support pedestal 12 and a winch motor 14. The winch support pedestal 12 houses a winch drum 16 which is connected to a winch motor 14 on a winch drum drive shaft 15. The winch motor 14 is configured to rotate a winch drum drive shaft 15 to spool a cable 18 onto or off the winch drum 16. Although this example refers to a cable any other suitable lines, such as rope, wire, umbilicals, pipes, cords or conduits lines may be used depending on the application. A brake assembly 17 provides braking torque to the winch drum drive shaft 15. The winch pedestal 12 has a bearing assembly 29 which can tolerate large axial or radial forces and may prevent the torque capacity of the winch motor 14 or brake assembly 17 being exceeded.

Although this example describes a single winch motor 14 on the winch drum drive shaft, a second winch motor may be located on the other end of the winch drum drive shaft 15 and may be used in combination with the first winch motor 14 to provide additional torque when winching/spooling heavy loads. A second brake assembly may also be located on the winch to provide additional braking torque. Alternatively the second winch motor hub may be used as a back-up motor in the event that the first winch motor 14 fails.

A spooling carriage 20 is attached to the winch support pedestal 12 and is supported by pivoting support arms 22 and 24 located on either side of the winch support pedestal 12. A benefit of providing support arms 22 and 24 is that they provide strength and support to the spooling carriage 20 and may mitigate the risk of damage or failure of the spooling carriage 20 by withstanding the stress and strains of heavy loads and sideways forces.

The spooling carriage 20 comprises a spooling guide assembly 34 which has a spooling rollers 36 configured to receive the cable 18. The spooling guide assembly 34 is configured to move in a horizontal reciprocating motion along spooling shaft 38 by a spooling shaft motor 40.

The spooling shaft motor 40 is controlled by a control unit 42 which is configured to position spooling rollers 36 in relation to the winch drum to facilitate efficient spooling. The control unit 42 uses feedback information relating to the winch drum rotational speed, spooling shaft motor speed and/or the location or horizontal motion of the spooling guide assembly 34 to ensure that cable is spooled onto or off the winch drum 16 in the most efficient manner. The control unit 42 facilitates the spooling rollers 36 being aligned with the cable 18 as it is spooled onto or off the winch drum 16 to mitigate tension on the cable 18 between the spooling rollers 36 and the winch drum 16.

The support arms 22 and 24 have a support plate 22a and 24a with an outer edge 22b and 24b which is substantially perpendicular to the support plate 22a and 24a. The outer edge 22b and 24b provides structural strength to the support arm and provide resistance to flexing, bending and twisting of the support arms 22 and 24. The support plate 22a and 24a of the support arms 22 and 24 provides an attachment surface for mounting components of the winch assembly such as a control unit or sensors 42. Depending on the height of the outer edge, the edge may provide protection to the components located on the support plate from damage.

The support plate 22a and 24a of the support arms 22 and 24 has a suitable width to prevent or provide resistance to bending or twisting of the support arm 22 and 24. Although this example refers to a support arm 22 and 24 having a support plate 22a and 24a with an outer edge 22b and 24b any other suitable support arm structures and dimensions is used that provide the support arm 22 and 24 with structural strength and prevent twisting, bending or flexing of the support arm 22 and 24.

The support arms 22 and 24 have slots 28 which are configured to receive one or more securing bolts 30. The winch support pedestal 12 has corresponding series of holes 32 located on either side of the winch support pedestal 12. The securing bolts are configured to extend through the slot 28 of the support arm and to be received in the hole 32 on the winch support pedestal 12. The securing bolts secure the position of the supporting arms 22 and 24 to the winch support pedestal 12. One or more securing bolts are located in the slots 28 and holes 32 on each support arm to secure the position of the supporting arms 22 and 24 relative to the winch support pedestal 12. The use of securing bolts is merely an example and any other manner of securing the supporting arms 22 and 24 to the winch support pedestal 12 may be used, such as securing pins or clamps.

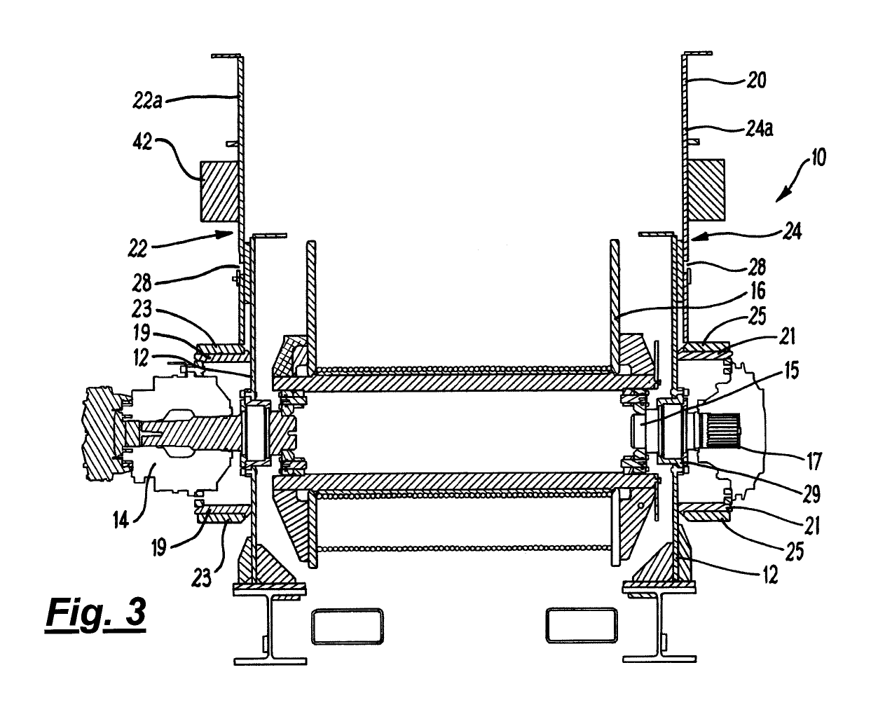

FIG. 3 shows an enlarged cross-sectional view of the winch to provide details on pivotally arrangement of the support arms 22 and 24 on the winch pedestal. Components of the winch and spooling carriage have been removed for clarity.

The support arms 22 and 24 are pivotally connected to the winch pedestal 12 via pedestal motor housing spigots 19 and 21 on the winch pedestal 12. The spigots 19 and 21 surround the winch axis and are coaxial with the winch axis.

At one end of the support arm 22 is located spigot ring 23. Spigot ring 23 has a suitably sized aperture which is configured to receive the spigot 19. The spigot ring 23 is pivotally connected to the spigot 19 and is configured to allow the support arms 22 to pivot about spigots 19. Similarly, at one end of the support arm 24 is located spigot ring 25. Spigot ring 25 has a suitably sized aperture which is configured to receive the spigot 21. The spigot ring 25 is pivotally connected to the spigot 21 and is configured to allow support arm 24 to pivot about spigots 21.

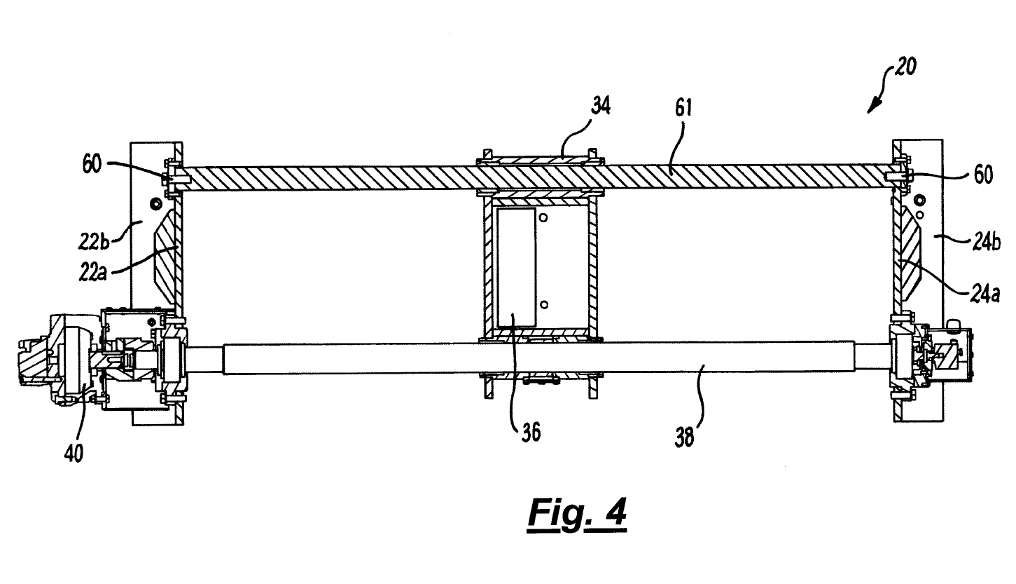

FIG. 4 show a spooling carriage a cross-sectional view. The view of the spooling carriage has been enlarged and is not to scale to provide details on the structure of the spooling carriage.

The inner surface of the distal ends of support plates 22a and 24a form the sides of the spooling carriage 20. The spooling carriage comprises a bar 61 which is secured between the support plate 22a and 24a of the support arms 22 and 24 and provides structural support to the spooling carriage. The bar 61 also provides support to the spooling guide assembly 34. Plates 63 (shown in FIG. 1) extend between the outer edges 22b and 24b of the support arms 22 and 24 to provide protection to the spooling guide assembly 34 and to provide additional rigidity to the spooling carriage.

Alternatively the spooling carriage may be a separate unit which is secured to the support arms 22 and 24. The separate unit may be affixed to the support plates 22a and 24a or the support plate edges 22b and 24b.

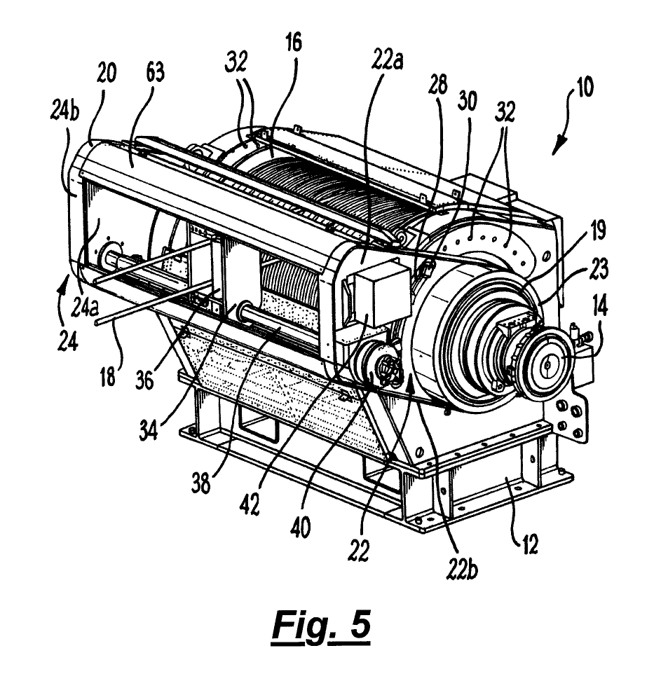

In use, depending on the application, a desired exit angle or discharge angle that the cable is to exit or enter the spooling guide assembly 34 is determined. The spooling carriage 20 is pivoted by rotating the support arms 22 and 24 about the spigots 19 and 21until the spooling guide assembly 34 is aligned with this predetermined desired angle. As can be seen in FIG. 5, the spooling carriage 20 is pivoted approximately zero degrees to the horizontal plane by pivoting support arms 22 and 24 about their pivots 19 and 21.

In this case the support arms 22 and 24 are pivoted about spigots 19 and 21 such that the spooling carriage is positioned approximately zero degrees to the horizontal plane.

The support arms 22 and 24 are pivotally supported by the spigots 19 and 21 on the winch pedestal. The load of the support arms, spooling carriage and/or cable is transferred to the winch pedestal via the support arrangement of the spigot rings 23 and 25 of support arms 22 and 23 and the spigots 19 and 21 of the winch pedestal. The spigots 19 and 21 provide load bearing support to the support arms 22 and 24 as the support arms pivot around the spigots 19 and 21.

The arrangement of the pair of parallel laterally-spaced support arms 22 and 24 on either side of the winch pedestal 12 also provide the spooling carriage with a rigid structure which provides strength and support to the spooling carriage against heavy winch loads and sideways forces.

Once the support arms 22 and 24 have been rotated about the spigots 19 and 21 and the spooling guide assembly 34 is aligned with a predetermined desired angle, in this case zero degrees to the horizontal plane, the support arms 22 and 24 are secured at this position. Securing bolts 30 are positioned in slot 28 of the support arms 22 and 24 and engage bolt holes 32 on the winch pedestal 12. The securing bolts are configured to secure the supporting arms 22 and 24 to the winch support pedestal 12 at the desired angle. Securing the support arms 22 and 24 provides further rigidity to the winch structure and provides additional support and strength to the spooling carriage and facilitates the spooling carriage withstanding heavy winch loads and sideways forces against sideways forces. Once the spooling carriage 20 is fixed in position the winching/spooling action is started.

To reposition the exit angle of the spooling carriage 20 from a first angle position to a second angle position relative to the horizontal and/or vertical plane for a different application, the securing bolts 30 are first removed from the holes 32 on the winch support pedestal 12 and slot 28 of the support arm 22. The support arms 22 and 24 of the spooling carriage 20 are pivoted about spigots 19 and 21 to position the spooling carriage 20 at a second desired angle relative to the horizontal plane. As the support arms are pivoted about the spigots 19 and 21 the load from the support arms 22 and 24 and spooling carriage 20 is transferred from the support arms 22 and 24 to the winch pedestal 14 via the arrangement of the spigot rings 23 and 25 on support arms 22 and 24 with the spigots 19 and 21 on the winch pedestal.

The securing bolts 30 are then repositioned in slot 28 of the support arms 22 and 24 and hole 32 on the winch support pedestal 12 to secure the support arms 22 and 24 to the winch support pedestal 12 at the second angle position. By securing the support arms 22 and 24 to the winch pedestal provides further rigidity to the winch structure and provides additional support and strength to the spooling carriage and facilitates the spooling carriage withstanding heavy winch loads and sideways forces. Once the spooling carriage 20 is fixed in position the winching/spooling action is started.

A winch assembly comprises a winch pedestal, a winch drum motor mounted on a winch drum drive shaft and configured to be driven to rotate on the winch pedestal about a winch axis and a spooling carriage supported by at least one support arm. The at least one support arm is pivotally connected to the winch pedestal via a hub. The hub surrounds the winch axis and pivotal movement of the at least one support arm rotates the spooling carriage relative to the winch pedestal.

During winch operations any stress or strains applied to the winch line or spooling carriage is transferred to the winch pedestal via the support arm 22 and 24 and spigots 19 and 21. The arrangement of the spigot ring 23 on support arm 22 with the spigot 19 on the winch pedestal is configured to transfer the load of the support arm 22 and any load support arm bears from the support arm to the winch pedestal structure. Similarly the arrangement of the spigot ring 25 on support arm 24 with the spigot 21 on the winch pedestal 12 is configured to transfer the load of the support arm 24 and any load which the support arm 24 bears from the support arm 24 to the winch pedestal structure.

The securing bolts 30 that secure the support arms 22 and 24 to bolt holes 32 on the winch pedestal 12 facilitate the transfer of load applied to the winch line or spooling carriage to the winch pedestal via the support arms. However, as the spigots also transfer a load or force applied to the winch line or spooling carriage to the winch pedestal via the support arms, the force transferred via the securing bolts may be reduced.

The load bearing support provided by the spigots and the securing bolts 30 may enable the spooling carriage and its support arms to withstand sideways forces exposed to the spooling carriage over a wide range of cable exit/entry angles.

The load bearing support provided by the spigots and the securing bolts 30 may enable the spooling carriage and its support arms to withstand sideways forces exposed to the spooling carriage over a wide range of cable exit/entry angles.

The winch assembly is able to perform tasks involving pulling in or paying out heavy loads at an increased fleet angle as the sideways or lateral forces acting on the spool guide are transferred via the support arms to the winch pedestal.

Another benefit of the improved spooling carriage is that it may improve the performance of the winch assembly by providing an independent spooling shaft motor which is controlled by a control unit. The control unit may monitor the rotational speed of the winch drum and the speed of movement and or location of the spooling guide assembly to ensure that the cable is spooled onto or off the winch drum in an orderly manner and mitigating cable tension and sideways forces between the spooling carriage and the winch drum.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers. Furthermore, relative terms such as”, “horizontal”, “vertical” and the like are used herein to indicate directions and locations as they apply to the appended drawings and will not be construed as limiting the invention and features thereof to particular arrangements or orientations. Likewise, the term “exit” shall be construed as being an opening which, dependent on the direction of the movement of a line such as a cable, and may also serve as an “entry”, and vice versa.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A winch assembly comprising:
a winch pedestal;
a winch drum mounted on a winch drum drive shaft and configured to be driven to rotate on the winch pedestal about a winch axis; and
a spooling carriage supported by at least one support arm;
wherein the at least one support arm is pivotally connected to the winch pedestal via a hub, wherein the hub surrounds the winch axis,
wherein pivotal movement of the at least one support arm rotates the spooling carriage relative to the winch pedestal and wherein the spooling carriage comprises a spooling guide assembly configured to move in a reciprocating motion.

2. The winch assembly as claimed in claim 1 further comprising a winch drive motor.

3. The winch assembly as claimed in claim 1 wherein the hub on the winch pedestal is a component of the winch pedestal housing or a component of a winch pedestal motor housing.

4. The winch assembly as claimed in claim 1 wherein the hub comprises a spigot.

5. The winch assembly as claimed in claim 4 wherein the spigot comprises a load bearing surface.

6. The winch assembly as claimed in claim 4 wherein the spigot is a load bearing pivot which is co-axial with the winch axis.

7. The winch assembly as claimed in claim 4 wherein the spigot has a cylindrical shape.

8. The winch assembly as claimed in claim 1 wherein the support arm comprises a support plate.

9. The winch assembly as claimed in claim 8 wherein the support plate comprises an outer edge or skirt which is upstanding from the support plate.

10. The winch assembly as claimed in claim 4 wherein the support arm has a spigot ring located at one end, and the spigot ring is pivotally connected to the spigot and is configured to pivot the support arms about the spigot.

11. The winch assembly as claimed in claim 4 wherein the at least one support arm is configured to rotate about the spigot to move the spooling guide assembly on the spooling carriage to a predetermined desired angle relative to the horizontal plane, the vertical plane, or both.

12. The winch assembly as claimed in claim 10 wherein the arrangement of the spigot ring on the support arm with the spigot on the winch pedestal is configured to transfer the load of the support arm and any load that the support arm bears from the support arm to the winch pedestal structure.

13. The winch assembly as claimed in claim 1 wherein the spooling carriage is supported by two support arms, wherein the support arms are pivotally connected to the winch pedestal via the hub.

14. The winch assembly as claimed in claim 13 wherein each support arm is pivoted either side of the winch pedestal such that the support arms are substantially parallel and laterally-spaced apart.

15. The winch assembly as claimed in claim 1 further comprising a locking mechanism configured to secure the support arm to the winch pedestal at a desired angle relative to the horizontal plane, the vertical plane, or both.

16. The winch assembly as claimed in claim 1 wherein the support arm is configured to pivot through an angle of at least sixty degrees.

17. The winch assembly as claimed in claim 1 wherein the support arm is configured to pivot through an angle of approximately ninety degrees.

18. A spooling carriage for a winch assembly comprising;
a spooling guide assembly; and
at least one support arm to support the spooling carriage;
wherein the at least one support arm is configured to be pivotally connected to a winch pedestal via a hub surrounding a winch axis of the winch assembly and wherein the spooling guide assembly is configured to move in a reciprocating motion.

19. The spooling carriage as claimed in claim 18 wherein the at least one support arm is configured to rotate the spooling carriage to any desired angle relative to the horizontal plane, the vertical plane, or both.

20. The spooling carriage as claimed in claim 18 further comprising a spooling shaft, wherein the spooling guide assembly is moved along the spooling shaft.

21. The spooling carriage as claimed in claim 18 wherein the spooling guide assembly is driven independently from the winch drive motor by a spooling shaft motor.

22. The spooling carriage as claimed in claim 18 further comprising a control unit configured to monitor or control the spooling shaft motor speed, the direction of travel of the spooling guide assembly along the spooling shaft, a winch drum rotational speed, or any combination thereof.

23. A method of configuring a winch assembly comprising the steps of:
providing a winch assembly comprising:
a winch pedestal;
a winch drum mounted on a winch drum drive shaft on a winch axis; and
a spooling carriage supported by at least one support arm wherein the spooling carriage comprises a spooling guide assembly configured to move in a reciprocating motion;
rotating the spooling carriage relative to the winch pedestal to a desired position by pivoting the at least one support arm about a hub which surrounds the winch axis; and
securing the spooling carriage relative to the winch pedestal at the desired position.

24. The method as claimed in claim 23 further comprising securing the spooling carriage relative to the winch pedestal by securing the at least one support arm to the winch pedestal.

25. The method as claimed in claim 23, further comprising the steps of:
releasing the spooling carriage from the winch pedestal,
rotating the spooling carriage relative to the winch axis to a second desired position and
securing the spooling carriage relative to the winch pedestal at the second desired position.

26. A method of operating a winch assembly comprising the steps of:
providing a winch assembly comprising:
a winch pedestal;
a winch drum mounted on a winch drum drive shaft and configured to be driven to rotate on the winch pedestal about a winch axis; and
a spooling carriage supported by at least one support arm;
wherein the at least one support arm is pivotally connected to the winch pedestal via a hub, wherein the hub surrounds the winch axis, and wherein pivotal movement of the at least one support arm rotates the spooling carriage relative to the winch pedestal;
pulling in or paying out a winch line; and
transferring a sideways force acting on the line to the winch pedestal via the at least one support arm.

27. The method as claimed in claim 26 further comprising driving a spooling guide assembly in the spooling carriage independently from the winch drum drive shaft.

28. The method as claimed in claim 26 further comprising monitoring a winch drum rotational speed, a spooling shaft motor or the position of a spooling guide assembly on a spooling shaft.
